(19) United States
(12) Patent Application Publication
(10) Pub. No.: US 2016/0045389 A1
(43) Pub. Date: Feb. 18, 2016

(54) LIP ENHANCER

(71) Applicant: Nigel Goonetilleke, Long Beach, CA (US)

(72) Inventor: Nigel Goonetilleke, Long Beach, CA (US)

(21) Appl. No.: 14/612,775

(22) Filed: Feb. 3, 2015

Related U.S. Application Data
(60) Provisional application No. 62/038,080, filed on Aug. 15, 2014.

(51) Int. Cl. A61H 9/00

(52) U.S. Cl. CPC A61H 9/0057; A61H 2205/022

(57) ABSTRACT

A lip enhancing device comprising a lip engaging inner portion, wherein the lip engaging inner portion is hollow and comprises mouthpiece which mouthpiece is placed over the lips of the user, further wherein the mouthpiece is attached to inner cylindrical elongate member, wherein inner cylindrical member culminates in two spaced apart O-rings, wherein inner cylindrical member travels within outer elongate portion. When the mouthpiece is place against the lips of the user and outer elongate portion is withdrawn, a vacuum is created, plumping or enhancing the lips of the user.

### CLAIM OF PRIORITY

This patent application claims priority under 35 USC 119 (e) (1) from U.S. Provisional Patent Application Ser. No. 62/038,080, filed Aug. 15, 2014, of common inventorship herewith entitled, “LIP ENHANCER,” which is incorporated herein by reference as though the same were set forth in its entirety.

### FIELD OF THE INVENTION

The present invention is directed to the field of cosmetic devices and more specifically to a mechanical device to plump the lips.

### BACKGROUND OF THE INVENTION

The prior art has put forth several inventions directed to the process of enhancing the lips. Among these are:

US Patent Application US2013/0046211 of Thienna Ho describes a lip enhancement and enlargement device including a suction element and a lip shaper coupled to the suction element.

U.S. Pat. No. 6,830,590 to Nicholas Palahnuk et al describes a method and apparatus for enhancing the lips comprising a clear or flesh colored polymer strip with a strong moisture activated adhesive on one side. A user inserts the apparatus on the inside of their lip with an attached applicator.

Neither of these devices describes the present invention.

### SUMMARY OF THE INVENTION

It is an object of the present invention to provide a simplified device to enhance the lips by applying suction to the lips.

It is a further object of the present invention to provide a device for applying suction to the lips wherein the device is inexpensive and easy to manufacture.

It is a still further object of the present invention to provide a device for applying suction to the lips wherein the device comprises only two parts.

It is a still further object of the present invention to provide a device for applying suction to the lips wherein the design of the device provides for repeated uses with one application of lubricant between the two parts.

### BRIEF DESCRIPTION OF THE DRAWINGS

FIG. 1 is a side view of the lip engaging inner portion of the device of the present invention.

FIG. 2 is a side view of the outer portion of the device of the present invention which receives the lip engaging inner portion.

FIG. 3 is a perspective view showing the lip engaging inner portion fully inserted into the outer portion of the device of the present invention.

FIG. 4 is a perspective view showing the lip engaging inner portion partially inserted into the outer portion of the device of the present invention.

FIG. 5 is a perspective view showing the lip engaging inner portion separated from the outer portion of the device of the present invention.

FIG. 6 is a side view of an alternative embodiment of the lip engaging inner portion of the device of the present invention.

### DETAILED DESCRIPTION OF THE INVENTION

As used herein, the term “portion” and the term “member” are equivalent. Full, plump lips are currently considered beautiful in our present culture. Chemical injections to produce full, plump lips can lead to complications. The present invention provides a device to quickly and safely apply suction to the lips creating the appearance of fuller, plump lips.

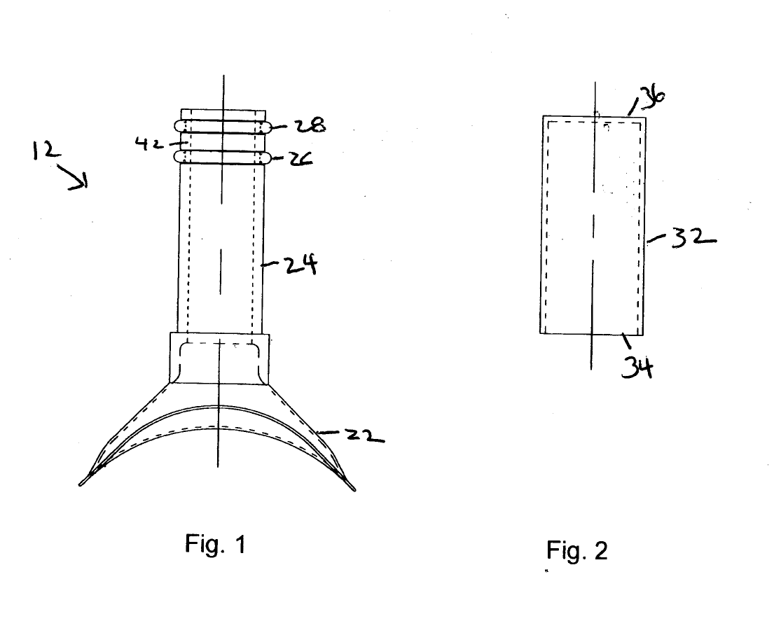

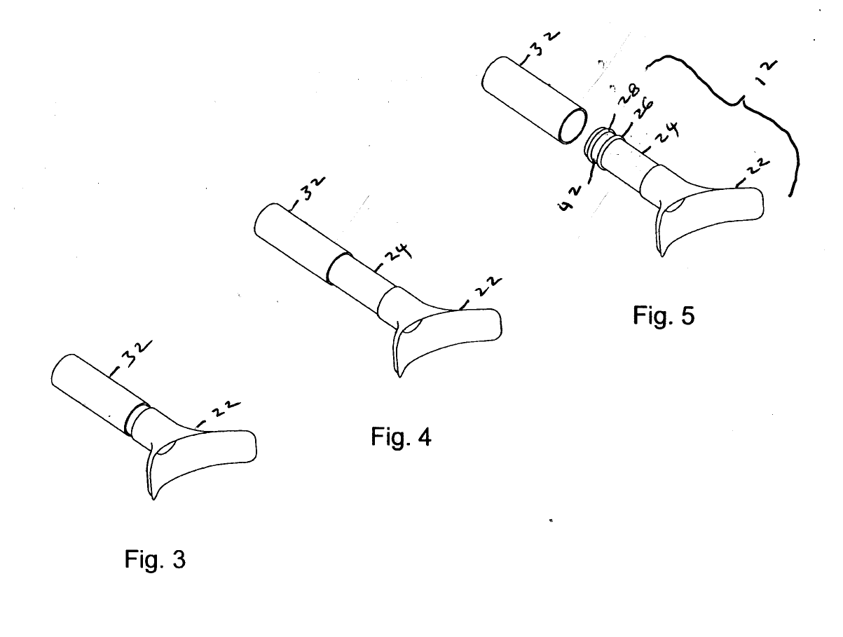

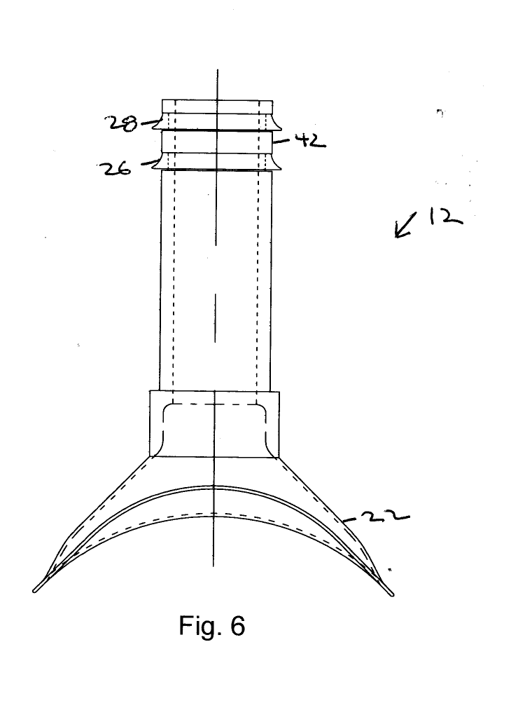

The present invention comprises a lip engaging inner portion, shown in FIG. 1. The lip engaging inner portion 12 is hollow and comprises mouthpiece 22, which is placed over the lips of the user. Mouthpiece 22 is attached to inner cylindrical elongate member 24. Inner cylindrical elongate member 24 culminates in two spaced apart O-rings 26 and 28. The O-rings are positioned near the distal end of inner cylindrical elongate member. The space between the O-rings is approximately one quarter inch to about one half inch. The space between O-ring 26 and O-ring 28 receives lubricant for creating a vacuum seal between lip engaging inner portion 12 and outer elongate portion 32. The space between the O-rings is approximately one quarter inch to about one half inch. The O-rings are parallel. In an embodiment, shown in FIG. 6, the parallel O-rings are flared so that the O-rings at their distal end is about one sixteenth of an inch smaller than the O-ring at its proximal end. Outer elongate portion 32 is open at proximal end 34 to receive lip engaging inner portion 12. Outer elongate portion 32 is closed at distal end 36. When lip engaging inner portion 12 is fully inserted into the open proximal end 34 of outer elongate portion 32 and mouthpiece 22 is placed against a user's mouth, a vacuum is created when the outer elongate portion 32 is withdrawn from the lip engaging inner portion 12 by pulling outer elongate portion 32 along cylindrical member 24. The vacuum thus created pulls the user's lips and causes fluid in the tissues to the surface thereby creating the look of fuller, plump lips. It must be noted that outer elongate portion 32 should not be pulled beyond first O-ring 26.

The present invention provides several advantages over prior art devices. The present device requires only two simple to manufacture parts which fit inside each other and are easy to disassemble for cleaning. Also, the area 42 between two spaced-apart O-rings 26, 28 provide a chamber for receiving lubricant. Because area 42 is bordered by O-rings on both the top and bottom, this helps to prevent the lubricant from drying out and requires re-application of lubricant less frequently. The lubricant permits the inner portion and outer portion to slide easily and form a vacuum seal when the mouthpiece 22 is placed against a user's mouth. Any suitable lubricant can be used.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A lip enhancing device comprising a lip engaging inner portion, wherein the lip engaging inner portion is hollow and comprises mouthpiece which mouthpiece is placed over the lips of the user, further wherein the mouthpiece is attached to inner cylindrical elongate member, wherein inner cylindrical member culminates in two spaced apart O-rings, wherein the O-rings are positioned near the distal end of the inner cylindrical member, and further wherein the space between the spaced apart O-rings is capable of receiving lubricant for creating a vacuum seal between lip engaging inner portion and outer elongate portion, wherein outer elongate portion has a distal end and a proximal end and further wherein outer elongate portion is open at proximal end to receive lip engaging inner portion, and further wherein outer elongate portion is closed at distal end, and further wherein inner cylindrical member travels within outer elongate portion.

2. The lip enhancing device of claim 1 wherein the O-rings are flared so that the O-ring at its distal end is about one sixteenth of an inch smaller than the O-ring at its proximal end.

3. The lip enhancing device of claim 2 wherein the flare of the O-rings is parallel.

4. The lip enhancing device of claim 3 where in the outer diameter of the O-rings is about one sixteenth of an inch greater than the outer diameter of the inner cylindrical member and flare out to about one eighth of an inch greater than the outer diameter of the inner cylindrical member.

5. The lip enhancing device of claim 1, wherein the space between the O-rings is approximately one quarter inch to about one half inch.

6. A method of enhancing human lips comprising fully inserting an inner cylindrical portion having a mouthpiece into an outer elongate portion and placing a mouthpiece against a user's mouth, withdrawing outer cylindrical elongate portion, creating a vacuum when the outer portion is withdrawn from the lip engaging inner portion and enhancing the lips by means of the vacuum created when the outer portion is pulled away from the inner portion.
